(19) United States
(12) Patent Application Publication
(10) Pub. No.: US 2006/0133325 A1
(43) Pub. Date: Jun. 22, 2006

(54) Method and apparatus for determing when to begin communication resource acquisition

(76) Inventors: John M. Harris, Chicago, IL (US); Pranavkumar L. Joshi, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/015,607

(22) Filed: Dec. 17, 2004

(51) Int. Cl. H04J 3/00

(52) U.S. Cl. 370/336; 370/498

(57) ABSTRACT

Various embodiments are described to address the need for an apparatus and method for communication resource acquisition that reduces the delay in acquiring resources without unduly wasting resources. In general, the described embodiments attempt to obtain desired resources in a just-in-time manner by using reasonably available information to characterize future packet transfers and calculate when resource acquisition should begin. The various embodiments involve calculating when to begin communication resource acquisition by considering a transfer-complete time, a ready-for-next-transfer time, an anticipated start time, and/or an anticipated acquisition time. In wireless communication systems (100), either the RAN (121) or the remote units (101) may be determining when to begin communication resource acquisition involving their air interface (111). Moreover, the desired resources may include, for example, uplink channels, downlink channels, supplemental channels, data-rate increases for certain channels, and/or FER decreases for certain channels.

### REFERENCE(S) TO RELATED APPLICATION(S)

This application is related to a co-pending application entitled “METHOD AND APPARATUS FOR PREDICTIVELY PROVIDING AN UPLINK COMMUNICATION RESOURCE,” filed on even date herewith, assigned to the assignee of the present application, and hereby incorporated by reference.

### FIELD OF THE INVENTION

The present invention relates generally to communication systems and, in particular, to communication resource acquisition.

### BACKGROUND OF THE INVENTION

Although the processes and messaging involved in communication resource acquisition for packet data varies from one radio access network (RAN) technology to the next, they typically share a fundamental inefficiency. In general, data packets are generated for transmission before the process of resource acquisition is initiated. For example, a remote unit first generates one or more packets and then requests the necessary uplink resources to transmit the packet. One justification for this approach is that wireless resources are usually quite limited in these systems. Allocating a limited wireless resource when it is not needed or for a longer period of time than it is needed is wasteful and costly.

Therefore, a need exists for an apparatus and method for communication resource acquisition that reduces the delay in acquiring resources without unduly wasting resources.

### BRIEF DESCRIPTION OF THE DRAWINGS

FIG. 1 is a block diagram depiction of a wireless communication system in accordance with multiple embodiments of the present invention.

FIG. 2 is a simplified timing diagram of exemplary packet-data signaling, employing one or more embodiments of the present invention, as compared to corresponding prior-art signaling.

FIG. 3 is a simplified timing diagram of exemplary packet-data signaling, employing one or more embodiments of the present invention, as compared to corresponding prior-art signaling.

FIG. 4 is a simplified timing diagram of exemplary packet-data signaling, employing one or more embodiments of the present invention, as compared to corresponding prior-art signaling.

FIG. 5 is a simplified timing diagram of exemplary packet-data signaling, employing one or more embodiments of the present invention, as compared to corresponding prior-art signaling.

FIG. 6 is a logic flow diagram of functionality performed in accordance with multiple embodiments of the present invention.

FIG. 7 is a logic flow diagram of functionality performed in accordance with certain packet-streaming embodiments of the present invention.

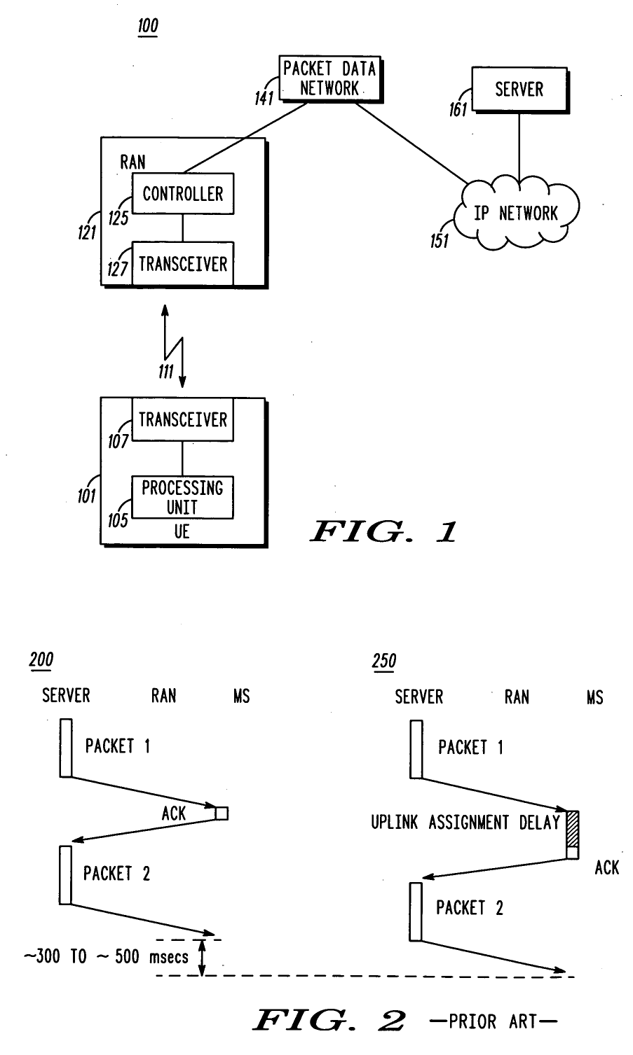

Specific embodiments of the present invention are disclosed below with reference to FIGS. 1-7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the need for an apparatus and method for communication resource acquisition that reduces the delay in acquiring resources without unduly wasting resources. In general, the described embodiments attempt to obtain desired resources in a just-in-time manner by using reasonably available information to characterize future packet transfers and calculate when resource acquisition should begin. The various embodiments involve calculating when to begin communication resource acquisition by considering a transfer-complete time, a ready-for-next-transfer time, an anticipated start time, and/or an anticipated acquisition time. In wireless communication systems, either the RAN or the remote units may be determining when to begin communication resource acquisition involving their air interface. Moreover, the desired resources may include, for example, uplink channels, downlink channels, supplemental channels, data-rate increases for certain channels, and/or FER decreases for certain channels.

The disclosed embodiments can be more fully understood with reference to FIGS. 1-7. FIG. 1 is a block diagram depiction of a wireless communication system 100 in accordance with multiple embodiments of the present invention. Communication system 100 represents a system having an architecture in accordance with one or more of the specifications described in the 3GPP (3rd Generation Partnership Project, which may be contacted via http://www.3gpp.orq/) standards (GSM, GPRS, EDGE, UMTS, HSDPA, HSUPA, E-UTRAN, etc.), suitably modified to implement the present invention. Alternative embodiments of the present invention may be implemented in communication systems that employ other (or additional) architectures/technologies such as, but not limited to, those specified in the 3GPP2 (3rd Generation Partnership Project 2, which may be contacted via http://www.3qpp2.com/) standards (IS-2000, e.g.), High Rate Packet Data (HRPD, HRPD-A, HRPD-B, which is also referred to as DO or IS-856) standards, and/or the IEEE's 802.11, 802.16 or 802.20 standards.

More specifically, communication system 100 comprises user equipment (UE) 101, radio access network (RAN) 121, packet data network 141, IP (internet protocol) network 151, and server 161. Those skilled in the art will recognize that FIG. 1 does not depict all of the network equipment necessary for system 100 to operate but only those system components and logical entities particularly relevant to the description of embodiments herein. For example, packet data networks are known to comprise devices such as Serving GPRS Support Nodes (SGSNs) and Gateway GPRS Support Nodes (GGSNs). Also, RANs are known to comprise devices such as base transceiver stations (BTSs), access points (APs), packet control units (PCUs), base site controllers (BSCs), and/or radio network controllers (RNCs), depending on which technology is employed. However, none of these are specifically shown in FIG. 1.

Instead, RAN 121 is depicted in FIG. 1 as comprising controller 125 and transceiver 127. In general, components such as RAN controllers and RAN transceivers are well-known. For example, RAN controllers are known to comprise basic components such as, but not limited to, microprocessors, memory devices, network interface circuitry, and/or logic circuitry. Such RAN components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, a call flow, and/or a protocol specification, those skilled in the art are aware of the many design and development techniques available to implement a RAN that performs the given logic. Furthermore, those skilled in the art will recognize that aspects of the present invention may be implemented in and across various physical components and none are necessarily limited to single platform implementations. For example, the RAN aspect of the present invention may be implemented in a base transceiver station, in a base/packet controller, or across both a base transceiver station and a base/packet controller.

Thus, RAN 121 represents a known RAN that has been adapted, in accordance with the description herein, to implement multiple embodiments of the present invention. Furthermore, controller 125 and transceiver 127 is not intended to precisely correspond to a base/packet controller and base transceiver station, respectively. Rather, controller 125 and transceiver 127 each represent devices that can extend across separate physical components that perhaps are not even co-located.

RAN 121 uses a 3GPP air interface such as a standard GPRS air interface for communication with UE 101. Thus, air interface 111 comprises uplink and downlink channels in accordance with the applicable 3GPP specification. For purposes herein, a generic uplink and downlink will be referred to with respect to air interface 111, since the embodiments discussed do not depend on channel types more particularly defined. In this way, the description can be simplified and made more clear to a person of skill in the art.

A remote unit/user equipment is known to refer to a wide variety of consumer electronic platforms such as, but not limited to, mobile stations (MSs), access terminals (ATs), terminal equipment, gaming devices, personal computers, personal digital assistants (PDAs), cable set-top boxes and satellite set-top boxes. In particular, MS 101 comprises processing unit 105, transceiver 107, a keypad (not shown), a speaker (not shown), a microphone (not shown), and a display (not shown). Processing units, transceivers, keypads, speakers, microphones, and displays as used in MSs are all well-known in the art.

For example, MS processing units are known to comprise basic components such as, but not limited to, microprocessors, digital signal processors (DSPs), microcontrollers, memory devices, and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic. Therefore, MS 101 represents a known MS that has been adapted, in accordance with the description herein, to implement embodiments of the present invention.

Operation of various embodiments in accordance with the present invention occur substantially as follows. In general, the various embodiments involve determining when to begin communication resource acquisition. In wireless communication system 100, either RAN 121 or UE 101 may be determining when to begin communication resource acquisition. Moreover, the communication resources acquired may be either uplink or downlink resources of air interface 111. To avoid redundancy and increase clarity, the description will focus primarily on embodiments in which uplink resources are being acquired by UE 101.

For the purposes of description, then, it will be assumed that UE 101 is receiving packets from server 161 via IP network 151, packet data network 141, RAN 121, and a downlink channel of air interface 111. Having detected that an uplink resource will be needed, processing unit 105, begins determining when UE 101 should begin acquiring an uplink resource in order to reduce any acquisition/assignment delays. To make this determination, processing unit 105 estimates an amount of time needed to complete the transfer of the current packet via the downlink, a transfer-complete time. The current packet referred to here is a receive packet that immediately precedes the UE's anticipated uplink signaling. Thus, it is a packet that needs to be successfully received before the uplink signaling.

Estimating the amount of time needed to complete the transfer of the current packet can be done in a variety of ways. Most directly, this could be by receiving an indication of the transfer-complete time from the packet sender. This could be done by using bits in the air interface signaling, packet header, or inter operability standard (IOS), for example. Less directly, the packet length, transfer rate and FER (frame erasure rate) or FER target can be used to calculate the total transfer time, from which a remaining time (i.e., the transfer-complete time) can be determined. The packet's length may be obtained from the corresponding logical link control (LLC) packet boundary indicator, estimated by using the length of a packet that preceded the current packet, or estimated based on what application is associated with the preceding packet. In embodiments where RAN controller 125 (instead of UE processing unit 105) is determining when to begin acquiring the uplink resource on behalf of UE 101, the current packet's own header could be used to obtain the packet length. In embodiments where UE processing unit 105 is determining when to begin acquiring the uplink resource, the current packet's own header which has been partially received at the UE, could be used to obtain the packet length.

Also relevant to estimating the transfer-complete time is determining whether the transfer of the current packet will involve a retransmission. If UE processing unit 105 detects an error in receiving the current packet or previous packets, the transfer-complete time is adjusted to account for re-transmission. For example, the amount of time for an automatic repeat request (ARQ) round-trip-time (RTT) could be added to the transfer-complete time. In embodiments where RAN controller 125 (instead of UE processing unit 105) is determining when to begin acquiring the uplink resource on behalf of UE 101, a packet error indicating a re-transmission could involve receiving a NAK for the current packet or previous packets.

Processing unit 105 also estimates an amount of time, a ready-for-next-transfer time, after the current packet's transfer is complete but before a next packet would be ready for transfer via the uplink resource. The ready-for-next-transfer time could therefore include an anticipated UE response time and UE packet generation time for the next packet. One way processing unit 105 may estimate this time is by determining what application is associated with the current packet. For example, the associated application may be ascertained by detecting the message type of the current packet. Then, using the known timing characteristics of the associated application/message type a ready-for-next-transfer time can be estimated.

For example, in the case where the associated application is a push-to-talk (PTT) application and the current packet is a Session Initiation Protocol (SIP) 200 OK packet, processing unit 105 would include in the ready-for-next-transfer time an amount of time for a talk permit tone (TPT) to be played by the UE, a UE audio sample interval to elapse, a silence interval after the user hears beep before beginning to speak, and time for the UE to encode the audio sample to be carried in the next packet via the uplink resource. The typical silence interval after a user hears a beep before beginning to speak may be 400 milliseconds, for example. For other packets (other than the SIP 200 OK, e.g.), the PTT application would likely have different timing characteristics to account for in the estimate of the ready-for-next-transfer time. Similarly, other applications would, of course, also have different timing characteristics for their particular messaging types.

In the case of TCP/IP packets, generally, packets may be marked as requiring or not requiring an immediate response. In many TCP/IP implementations, the target (UE 101, e.g.) maintains a response timer, which expires every ˜THOLD msecs. When the target receives a packet, it waits until the next expiration of this response timer, before sending an acknowledgment. Thus, when the current packet comprises a TCP/IP packet that is not marked as requiring an immediate response, processing unit 105 would include in the ready-for-next-transfer time an amount of time for the corresponding UE 101 response timer to expire.

In contrast to the embodiments already described above, certain embodiments may handle packet-streaming situations somewhat differently. Instead of estimating the transfer-complete time and the ready-for-next-transfer time using a current downlink packet, some embodiments will use previous uplink packets to anticipate the transfer start time of a next uplink packet associated with the stream. An assumption is made that the uplink packets associated with a packet stream will be substantially periodic.

In addition to estimating the transfer-complete time and the ready-for-next-transfer time or, in the case of certain packet-stream embodiments, anticipating the transfer start time, processing unit 105 also estimates an acquisition time that represents how much time will be needed to acquire a communication resource once acquisition begins. This acquisition time will, of course, depend on a variety of factors, some of which are determined by the particular embodiment employed. For example, a larger acquisition time may be involved for embodiments in which the remote unit sends a request for the communication resource to the RAN as compared to embodiments in which the RAN merely performs the allocation process for the communication resource.

Other factors that may potentially affect the anticipated acquisition time include what communication resource is being acquired and the duration for which it is being acquired. Again, depending on the embodiment the communication resource may be an uplink channel, a downlink channel, a supplemental channel, or even an increased data rate or decreased FER (frame erasure rate) for an already allocated channel. Resource acquisition, in some embodiments, involves specifying a duration for which the resource is desired. Thus, a resource duration may also need to be estimated by UE processing unit 105. One way to do this would be by using the length of one or more previously transferred packets. For example, UE processing unit 105 could simply use the length of the last packet sent via the uplink in estimating the next packet's length, at least for purposes of anticipating the acquisition time.

Having estimated the resource acquisition time, the transfer-complete time and the ready-for-next-transfer time, processing unit 105 calculates the time at which it will begin acquiring the communication resource. This calculation involves taking the current time, adding the transfer-complete time, adding the ready-for-next-transfer time, and subtracting the anticipated acquisition time. For certain packet-stream embodiments, the calculation involves subtracting the anticipated acquisition time from the anticipated start time. Additionally, this estimate of the maximum size of the next subsequent packet, may leverage the known property of vocoders, whereby the voice activity level changes slowly over time, such that a subsequent voice sample is typically the same size as the previous sample or at least not substantially larger.

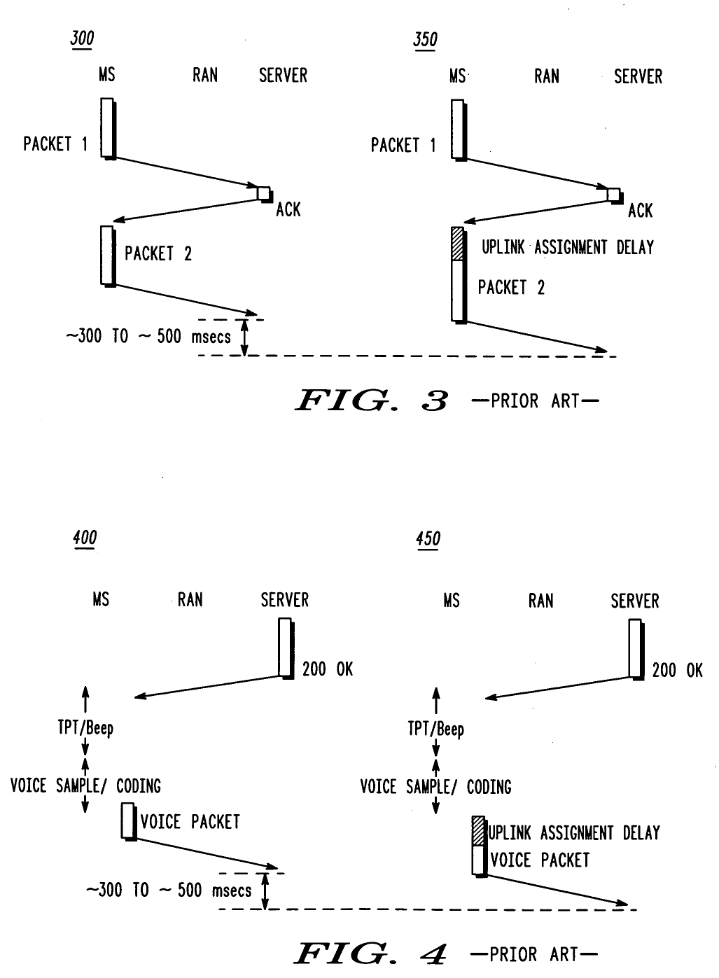

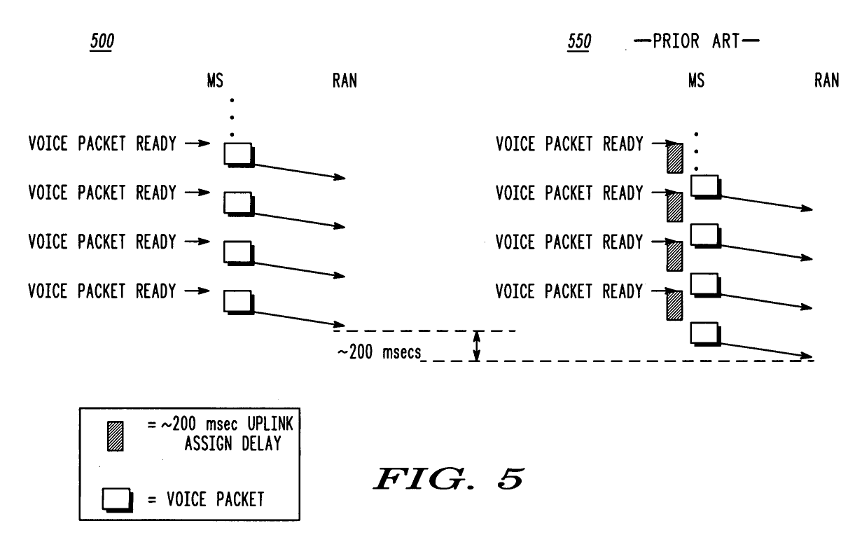

FIGS. 2-5 depict simplified timing diagrams (200, 300, 400, 500) of exemplary packet-data signaling, employing one or more embodiments of the present invention, as compared to corresponding prior-art signaling (250, 350, 450, 550). FIGS. 2-5 help to illustrate the potential benefit of beginning to acquire desired communication resources earlier in time than the prior art does. The FIGS. each provide example signaling for different situations. For example, FIG. 2 depicts a server downloading to a remote unit; FIG. 3 depicts a remote unit upload; FIG. 4 depicts a remote unit receiving SIP 2000K signaling for a PTT application; and FIG. 5 depicts a remote unit streaming voice packets to a RAN. In general, the embodiments described and depicted attempt to obtain desired resources in a just-in-time manner by using reasonably available information to characterize future packet transfers and calculate when resource acquisition should begin.

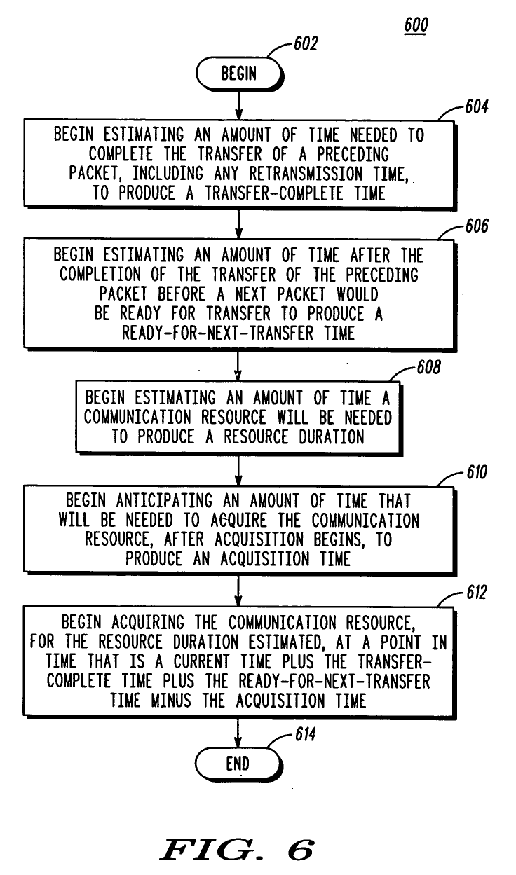

FIG. 6 is a logic flow diagram of functionality performed in accordance with multiple embodiments of the present invention. Logic flow 600 begins (602) when a device detects that a communication resource will be needed by itself or another device with which it is communicating. The device begins estimating (604) an amount of time needed to complete the transfer of a preceding packet, including any retransmission time that will be required, in order to produce a transfer-complete time. The device also begins estimating (606) an amount of time after the completion of the transfer of the preceding packet before a next packet would be ready for transfer in order to produce a ready-for-next-transfer time. The device may also begin estimating (608) an amount of time that the communication resource will be needed in order to produce a resource duration. In addition, the device begins (610) anticipating an amount of time that will be needed to acquire the needed communication resource, after acquisition begins, in order to produce an acquisition time.

Although logic flow 600 depicts the device determining each of these time intervals sequentially and in a particular order, they may also be determined concurrently and/or in a different order. Finally, the device begins acquiring (612) the communication resource, for the resource duration (if determined), at a point in time that is the current time plus the transfer-complete time, plus the ready-for-next-transfer time, minus the acquisition time. Logic flow 600 thus ends (614).

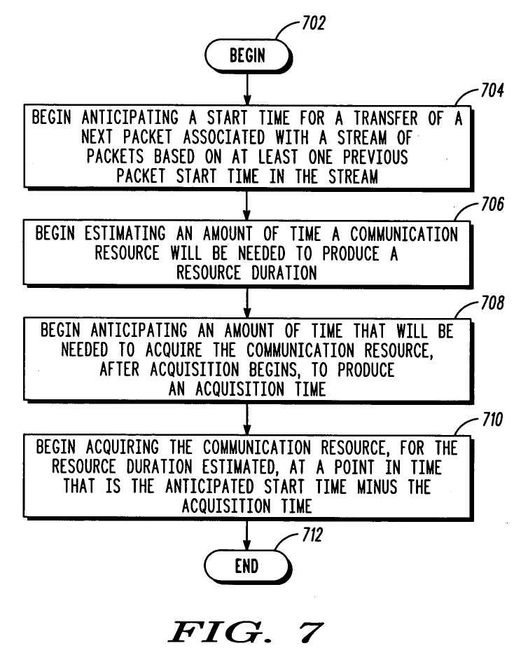

FIG. 7 is a logic flow diagram of functionality performed in accordance with certain packet-streaming embodiments of the present invention. Logic flow 700 begins (702) when a device detects that a communication resource will be needed by itself or another device with which it is communicating. The device begins anticipating (704) a start time for the transfer of a next packet associated with a stream of packets based on at least one previous packet start time. The device may also begin estimating (706) an amount of time that the communication resource will be needed in order to produce a resource duration. In addition, the device begins (708) anticipating an amount of time that will be needed to acquire the needed communication resource, after acquisition begins, in order to produce an acquisition time.

Although logic flow 700 depicts the device determining each of these time intervals sequentially and in a particular order, they may also be determined concurrently and/or in a different order. Finally, the device begins acquiring (710) the communication resource, for the resource duration (if determined), at a point in time that is the anticipated start time minus the acquisition time. Logic flow 700 thus ends (712).

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for determining when to begin communication resource acquisition comprising:
estimating an amount of time needed to complete a transfer of a preceding packet to produce a transfer-complete time;
estimating an amount of time after the completion of the transfer of the preceding packet before a next packet would be ready for transfer to produce a ready-for-next-transfer time;
anticipating an amount of time that will be needed to acquire a communication resource after acquisition begins to produce an acquisition time, wherein the communication resource is needed to transfer the next packet; and
beginning at a point in time to acquire the communication resource, wherein the point in time is a current time plus the transfer-complete time plus the ready-for-next-transfer time minus the acquisition time.

2. The method of claim 1, wherein estimating the amount of time needed to complete the transfer of the preceding packet to produce the transfer-complete time comprises
determining a length of the preceding packet and a transfer rate of the preceding packet.

3. The method of claim 2, wherein determining the length of the preceding packet comprises using an indicator of length from the group of sources consisting of a
header of the preceding packet,
a length of at least one packet that precedes the preceding packet,
an application associated with the preceding packet, and
a logical link control (LLC) packet boundary indicator.

4. The method of claim 1, wherein estimating the amount of time needed to complete the transfer of the preceding packet to produce the transfer-complete time comprises
detecting whether the transfer of the preceding packet will involve a retransmission.

5. The method of claim 4, wherein estimating the amount of time needed to complete the transfer of the preceding packet to produce the transfer-complete time comprises
when the transfer of the preceding packet will involve a retransmission, including in the transfer-complete time an amount of time for an automatic repeat request (ARQ) round-trip-time (RTT).

6. The method of claim 1, wherein estimating the amount of time needed to complete the transfer of the preceding packet to produce the transfer-complete time comprises
receiving, apart from the preceding packet itself, an indication of the transfer-complete time from the sender of the preceding packet.

7. The method of claim 1, wherein estimating the amount of time after the completion of the transfer of the preceding packet before the next packet would be ready for transfer to produce the ready-for-next-transfer time comprises
including in the ready-for-next-transfer time an amount of time for at least one of an anticipated receive-device response time and a packet generation time for the next packet.

8. The method of claim 1, wherein estimating the amount of time after the completion of the transfer of the preceding packet before the next packet would be ready for transfer to produce the ready-for-next-transfer time comprises
estimating the amount of time before the next packet would be ready for transfer based on an application associated with the preceding packet.

9. The method of claim 8, wherein estimating the amount of time before the next packet would be ready for transfer based on an application associated with the preceding packet comprises
when the application associated with the preceding packet is a push-to-talk application and the preceding packet is a Session Initiation Protocol (SIP) 2000K packet, including in the ready-for-next-transfer time an amount of time for at least one of a talk permit tone (TPT) to be played, an audio sample interval to elapse, an audio sample to be encoded, and a user response time after hearing the TPT before beginning to speak.

10. The method of claim 1, wherein estimating the amount of time after the completion of the transfer of the preceding packet before the next packet would be ready for transfer to produce the ready-for-next-transfer time comprises
when the preceding packet comprises a TCP/IP packet that is not marked as requiring an immediate response, including the in the ready-for-next-transfer time an amount of time for a receive-device response timer to expire.

11. The method of claim 1, wherein beginning to acquire the communication resource comprises a step from the group consisting of
sending a request for the communication resource and
beginning the allocation process of the communication resource by a radio access network (RAN) for a remote unit without first receiving a corresponding request for the communication resource.

12. The method of claim 1, wherein the communication resource comprises a resource from the group consisting of an uplink channel, a downlink channel, a supplemental channel, and an increase in a data rate.

13. The method of claim 1, further comprising:
estimating an amount of time the communication resource will be needed to produce a resource duration, wherein beginning to acquire the communication resource comprises beginning to acquire the communication resource for the resource duration.

14. The method of claim 13, wherein estimating the amount of time the communication resource will be needed by the remote unit to produce the resource duration comprises a step from the group consisting of
estimating a length of the next packet based on a length of at least one preceding packet and
estimating a length of the next packet based on a number of voice samples per packet.

15. A method for determining when to begin communication resource acquisition comprising:
anticipating a start time for a transfer of a next packet associated with a stream of packets based on at least one previous packet start time, wherein both the at least one previous packet and the next packet are associated with a stream of packets;
anticipating an amount of time that will be needed to acquire a communication resource after acquisition begins to produce an acquisition time, wherein the communication resource is needed to transfer the next packet; and
beginning at a point in time to acquire the communication resource, wherein the point in time is the anticipated start time minus the acquisition time.

16. The method of claim 15, wherein beginning to acquire the communication resource comprises a step from the group consisting of
sending a request for the communication resource and
beginning the allocation process of the communication resource by a radio access network (RAN) for a remote unit without first receiving a corresponding request for the communication resource.

17. The method of claim 15, wherein the communication resource comprises a resource from the group consisting of an uplink channel, a downlink channel, a supplemental channel, an increase in a data rate, and a decrease in FER.

18. The method of claim 15, further comprising:
estimating an amount of time the communication resource will be needed to produce a resource duration, wherein beginning to acquire the communication resource comprises beginning to acquire the communication resource for the resource duration.

19. The method of claim 18, wherein estimating the amount of time the communication resource will be needed by the remote unit to produce the resource durations comprises a step from the group consisting of
estimating a length of the next packet based on a length of at least one preceding packet and
estimating a length of the next packet based on a number of voice samples per packet.

20. A communication device comprising:
means for estimating an amount of time needed to complete a transfer of a preceding packet to produce a transfer-complete time;
means for estimating an amount of time after the completion of the transfer of the preceding packet before a next packet would be ready for transfer to produce a ready-for-next-transfer time;
means for anticipating an amount of time that will be needed to acquire a communication resource after acquisition begins to produce an acquisition time, wherein the communication resource is needed to transfer the next packet; and
means for beginning at a point in time to acquire the communication resource, wherein the point in time is a current time plus the transfer-complete time plus the ready-for-next-transfer time minus the acquisition time.
